(19) United States
(12) Patent Application Publication
(10) Pub. No.: US 2007/0056420 A1
(43) Pub. Date: Mar. 15, 2007

(54) Single-hole puncher with ease of alignment

(76) Inventor: Tung Yan Lau, Hong Kong (HK)

Correspondence Address: Mr. Eric Chan, 42 Pin Oaks Drive, Phoenixville, PA, 19460, US

(21) Appl. No.: 11/305,004

(22) Filed: Dec. 19, 2005

(30) Foreign Application Priority Data
Sep. 13, 2005 (CN) 200520118772.1

(51) Int. Cl. B26D 5/08; B26D 1/14

(52) U.S. Cl. 83/571; 83/681

(57) ABSTRACT

The present invention relates to a single-hole puncher with ease of alignment comprising a base and a punching unit; the punching unit is disposed on the base; a hole is disposed on the base in a position corresponding to the punching unit; a L-shaped right-angle receptacle with two vertical flanges is disposed between the base and the punching unit; the punching unit and the right-angle receptacle are vertically disposed facing each other. Since the L-shaped right-angle receptacle of the present single-hole puncher allows convenient and efficient paper alignment, the present invention, in comparison with available single-hole punchers, has the advantages of being simple in construction, easy to operate, convenient to be carried around and of high punching efficiency and precision. It can also punch binding holes of various distances in between. The structure of the L-shaped right-angle receptacle can be widely applied to various types of single-hole punchers and even two-hole (multiple-hole) punchers.

### BACKGROUND OF THE INVENTION

The present invention relates to paper punchers and more particularly pertains to a single-hole puncher with ease of alignment in the field of punching apparatus for document binding.

Available paper punchers in the marketplace are generally categorized into single-hole punchers and two-hole punchers. Two-hole punchers give two binding holes on paper sheets in one single punch, but they are generally larger in size and provide the two binding holes with fixed distance in between. Distance between the two binding holes therefore cannot be adjusted with paper size. Available single-hole punchers are usually more compact in size and convenient to be carried around. They operate by punching one hole on paper sheets each time or by punching several holes at a time on folded paper sheets. Since distance is not restricted, they can give binding holes of different distances in between. However, the available single-hole punchers generally fail to punch new holes accurately. Since the available single-hole punchers can only limit the depth of insertion of paper sheets but cannot fix the up and down position of paper sheets in direction perpendicular to that of paper insertion, it is difficult to align paper sheets accurately. Therefore, there may be displacement of holes on separately punched paper sheets, which makes binding difficult. Some of the available single-hole punchers are disposed with additional alignment devices to fix the position of paper sheets for accurate punching. This type of single-hole punchers is, however, of more complicated construction and is inconvenient to operate and to be carried around.

### BRIEF SUMMARY OF THE INVENTION

In view of the aforesaid disadvantages now present in the prior art, the object of the present invention is to provide a single-hole puncher with ease of alignment. It has the advantages of being simple in structure, easy to operate and convenient to be carried around, thus facilitating efficient paper alignment and punching.

To attain this, the present invention generally comprises a base and a punching unit; the punching unit is disposed on the base; a hole is disposed on the base in a position corresponding to the punching unit, wherein a L-shaped right-angle receptacle with two vertical flanges is disposed between the base and the punching unit; the punching unit and the right-angle receptacle are vertically disposed facing each other.

The two vertical flanges of the right-angle receptacle join to form a close structure or are disposed.apart at a certain distance.

The two vertical flanges of the right-angle receptacle are formed by projections from the base, or are formed by connecting the base with the punching unit.

The distance between one of the vertical flanges of the right-angle receptacle and the center of the hole on the base is 38 mm to 42 mm, while the distance between the other vertical flange and the center of the hole on the base is 10 mm to 30 mm.

The punching unit comprises a ram recess, a punch ram, a spring, an actuating rod and a roller bead. The punch ram is inserted into the ram recess; the punch ram and the ram recess are connected with the spring in between; the actuating rod is disposed above the punch ram in a position corresponding to the end of the punch ram. When the actuating rod is pressed down, the punch ram will be pushed downward to punch paper.

An actuating cover is disposed above the actuating rod. A recess for pressing is provided on the surface of the actuating cover. To facilitate ease of pressing and avoid slipping of hand, the surface of the recess may be provided with dots or protruding patterns.

A cavity is provided inside the base for storage of paper discs punched out.

The present single-hole puncher is disposed with a L-shaped right-angle receptacle. If the relative distances between the two vertical flanges of the right-angle receptacle and the punch ram of the punching unit are standard values, when a corner of a paper sheet is inserted into the right-angle receptacle in a manner that the two right-angle edges of the paper sheet contact the two vertical flanges of the right-angle receptacle closely, the hole produced by the punching unit will be in a standard position. Paper sheets punched by the present single-hole puncher can therefore be aligned and bound together accurately. Two standard binding holes can be produced at a time by folding up a paper sheet in half, inserting it into the right-angle receptacle in a manner that it contacts the vertical flanges closely, and punching.

Since the L-shaped right-angle receptacle allows convenient and efficient paper alignment, the present single-hole puncher, in comparison with available single-hole punchers in the marketplace, has the advantages of being simple in construction and easy to operate and use and of high punching efficiency and precision. It also has the advantages over available two-hole punchers of being simple in construction and convenient to be carried around and can punch binding holes of various distances in between.

The structure of the L-shaped right-angle receptacle can be widely applied to various types of single-hole punchers and even two-hole (multiple-hole) punchers available in the marketplace.

### BRIEF DESCRIPTION OF THE DRAWINGS

FIG. 1 shows the exterior view of the present single-hole puncher.

FIG. 2 shows the shape of the right-angle receptacle of the single-hole puncher of FIG. 1.

FIG. 3 shows the symmetrical cross-sectional view of the single-hole puncher of FIG. 1.

FIG. 4 shows the cross-sectional view along the direction of B-B of the single-hole puncher of FIG. 1.

FIG. 5 shows the flow chart of the punching operation of the single-hole puncher of FIG. 1.

### DETAILED DESCRIPTION OF THE INVENTION

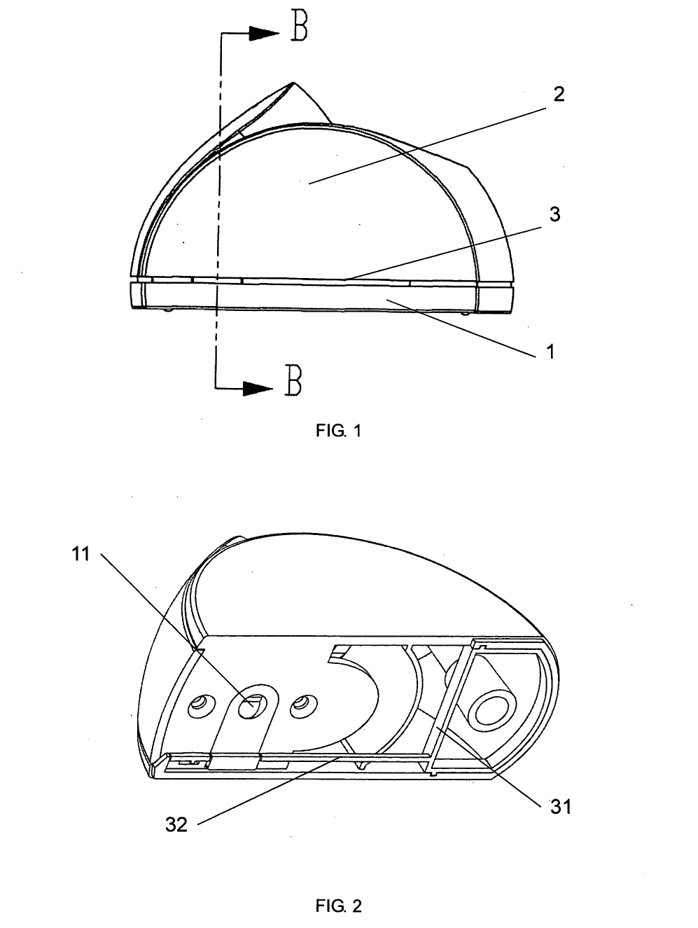

The present invention is further described in detail with the following embodiments and the accompanying drawings. FIGS. 1 to 4 show the structure of the present invention. As illustrated in FIG. 1, the present embodiment comprises a base 1, a casing 2 and a punching unit. The punching unit is disposed in the casing 2 and on the base 1. A L-shaped right-angle receptacle 3 with two vertical flanges is disposed between the casing 2, the punching unit and the base 1. As illustrated in FIG. 2, the two vertical flanges 31, 32 of the right-angle receptacle 3 join to form a close right-angle structure. The two vertical flanges 31, 32 are formed by projections from the base 1. The punching unit and the right-angle receptacle 3 are vertically disposed facing each other. A hole 11 is disposed on the base 1 in a position corresponding to the punching unit. In other embodiments, the two vertical flanges 31, 32 of the right-angle receptacle 3 can be disposed apart at a certain distance and the two vertical flanges 31, 32 can be formed by connecting the base 1 with the punching unit. In this embodiment, the distance between the vertical flange 31 of the right-angle receptacle 3 and the center of the hole 11 is 40 mm, while the distance between the vertical flange 32 and the center of the hole 11 is 13 mm. These two measurements are standard values. In other embodiments, other standard values or non-standard values can be used.

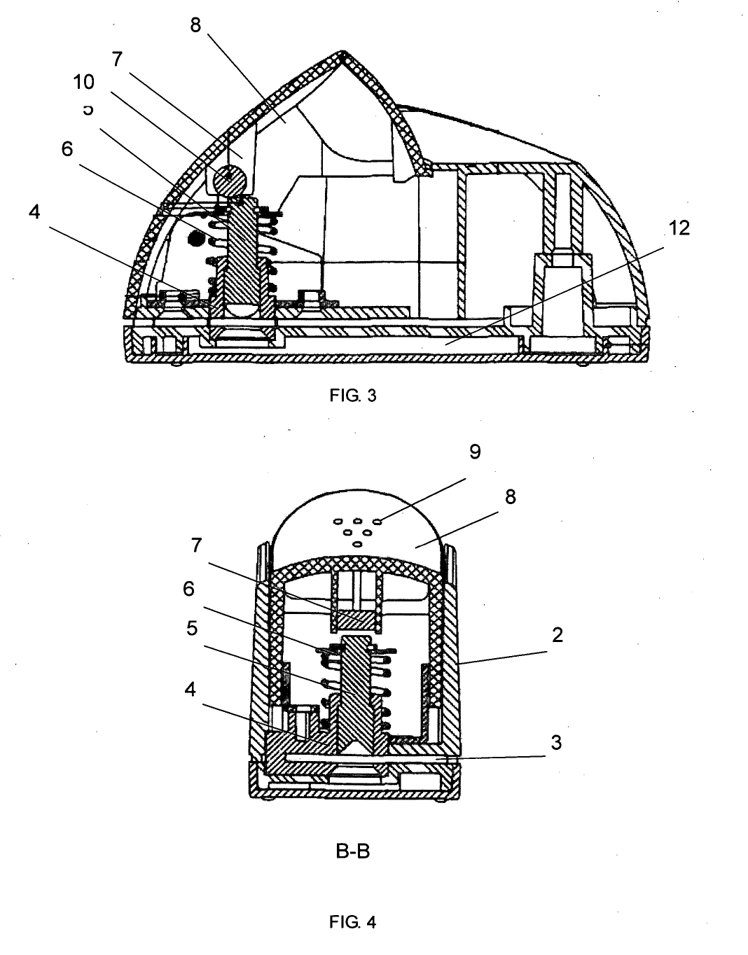

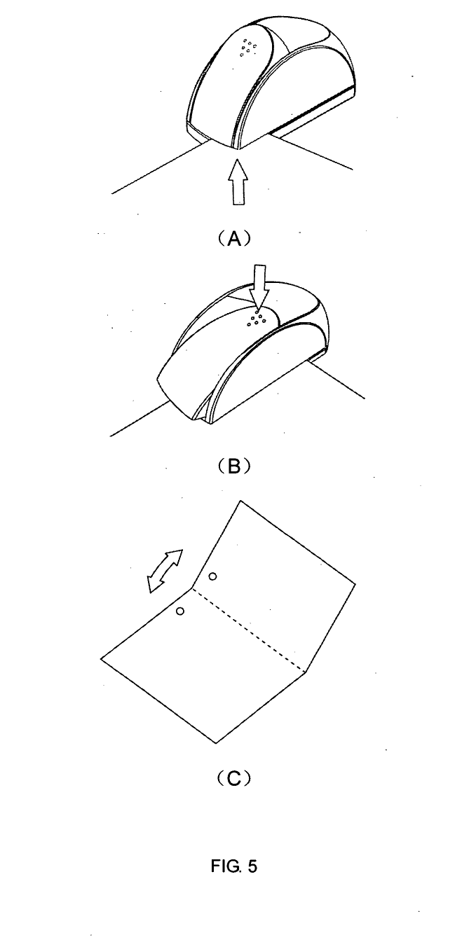

FIGS. 3 and 4 show the structure of the punching unit. As illustrated in the figures, the punching unit comprises a ram recess 4, a punch ram 5, a spring 6, an actuating rod 7 and a roller bead 10. The punch ram 5 is inserted into the ram recess 4; the punch ram 5 and the ram recess 4 are connected with the spring 6 in between; the actuating rod 7 and the roller bead 10 are disposed above the punch ram 5 in a position corresponding to the end of the punch ram 5. When the actuating rod 7 is pressed down, the roller bead 10 will be pushed and the punch ram 5 will consequently be pushed downward into the hole 11 of the base 1 to punch paper. An actuating cover 8 is disposed above the actuating rod 7. A recess for pressing is provided on the surface of the actuating cover 8. To facilitate ease of pressing and avoid slipping of hand, the surface of the recess may be provided with dots 9 or protruding patterns (not shown). A cavity 12 is provided inside the base 1 for storage of paper discs punched out.

Descriptions on other structures of this embodiment will not be provided as they are similar to the above-mentioned embodiment.

FIG. 5 illustrates the operation of the present single-hole puncher. If the relative distances between the two vertical flanges 31, 32 of the right-angle receptacle 3. and the hole 11 of the base 1 (i.e. the relative distances with the punch ram 5 of the punching unit) are standard values, which are 40 mm and 13 mm respectively in this embodiment, when a paper sheet to be punched is folded up in half and a corner of it is inserted into the right-angle receptacle 3 in a manner that the two right-angle edges of the folded paper contact the two vertical flanges 31, 32 of the right-angle receptacle 3 closely, as illustrated in FIG. 5(A), two punching holes at standard positions can be produced by pressing the actuating cover 8 so that the actuating rod 7 pushes the punch ram 5 downward to punch the paper sheet, as illustrated in FIG. 5(B). The paper sheet can then be removed from the puncher and unfolded as in FIG. 5(C).

The above are preferred embodiments of the present invention. With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A single-hole puncher with ease of alignment comprising a base and a punching unit; the punching unit is disposed on the base; a hole is disposed on the base in a position corresponding to the punching unit, wherein a L-shaped right-angle receptacle with two vertical flanges is disposed between the base and the punching unit; the punching unit and the right-angle receptacle are vertically disposed facing each other.

2. The single-hole puncher with ease of alignment as in claim 1, wherein the two vertical flanges of the right-angle receptacle join to form a close structure.

3. The single-hole puncher with ease of alignment as in claim 1, wherein the two vertical flanges of the right-angle receptacle are disposed apart at a certain distance.

4. The single-hole puncher with ease of alignment as in claim 1, wherein the two vertical flanges of the right-angle receptacle are formed by projections from the base.

5. The single-hole puncher with ease of alignment as in claim 1, wherein the two vertical flanges of the right-angle receptacle are formed by connecting the base with the punching unit.

6. The single-hole puncher with ease of alignment as in claim 1, wherein the distance between one of the vertical flanges of the right-angle receptacle and the center of the hole on the base is 38 mm to 42 mm, while the distance between the other vertical flange and the center of the hole on the base is 10 mm to 30 mm.

7. The single-hole puncher with ease of alignment as in claim 1, wherein the punch ram is inserted into the ram recess; the punch ram and the ram recess are connected with the spring in between; the actuating rod is disposed above the punch ram in a position corresponding to the end of the punch ram.

8. The single-hole puncher with ease of alignment as in claim 7, wherein an actuating cover is disposed above the actuating rod.

9. The single-hole puncher with ease of alignment as in claim 1, wherein a cavity is provided inside the base for storage of paper discs punched out.
